(19) United States
(12) Patent Application Publication
(10) Pub. No.: US 2014/0325165 A1
(43) Pub. Date: Oct. 30, 2014

(54) MEMORY APPARATUS AND MEMORY MANAGEMENT METHOD

(71) Applicant: Sony Corporation, Tokyo (JP)

(72) Inventors: Seiji KOBAYASHI, Kanagawa (JP); Takeshi KUBO, Kanagawa (JP); Michiaki YASUI, Kanagawa (JP); Takeharu TAKASAWA, Kanagawa (JP); Naofumi GOTO, Kanagawa (JP)

(73) Assignee: Sony Corporation, Tokyo (JP)

(21) Appl. No.: 14/254,527

(22) Filed: Apr. 16, 2014

(30) Foreign Application Priority Data
Apr. 30, 2013 (JP) 2013-094963

(51) Int. Cl. G06F 12/02

(52) U.S. Cl. CPC G06F 12/02
USPC 711/154

(57) ABSTRACT

A memory apparatus includes a detection unit, a storage unit, an update unit, and a determination unit. The detection unit is configured to detect a deterioration factor of a nonvolatile memory. The storage unit is configured to hold a lifetime estimation value. The update unit is configured to update the lifetime estimation value on the basis of the deterioration factor detected by the detection unit. The determination unit is configured to use the lifetime estimation value updated by the update unit to generate a notification signal.

### CROSS REFERENCES TO RELATED APPLICATIONS

The present application claims priority to Japanese Priority Patent Application JP 2013-094963 filed in the Japan Patent Office on Apr. 30, 2013, the entire content of which is hereby incorporated by reference.

### BACKGROUND

The present disclosure relates to a memory apparatus and a memory management method applied to a nonvolatile memory such as a nonvolatile semiconductor memory.

In recent years, prices of nonvolatile semiconductor memories have been increasingly lowered, and the nonvolatile semiconductor memories are used for one purpose after another. As one of the purposes, it is conceived that a nonvolatile semiconductor memory is contained in a plastic medium and is used as a substitution of a tape medium in the past.

As one of the nonvolatile memories, a magnetic storage apparatus (hard disk, magnetic tape, or the like) is known. For example, in a broadcast station, a data center, or the like, a tape medium is used for a long-term storage of data. In the case of the tape medium, with respect to deterioration, a deterioration condition is evaluated, and a tape medium which has deteriorated has to be copied to a new tape medium. However, if there are a great number of volumes, there is a problem that the task involves a tremendous amount of time and effort.

It is also conceived that, instead of the tape medium, a nonvolatile semiconductor memory is contained in a cartridge and used in the same way as a tape cartridge. The prices of the nonvolatile semiconductor memories have been rapidly lowered in recent years. In addition, when a nonvolatile semiconductor memory is used, an expensive drive apparatus is unnecessary for read, and only by connecting an interface to a power supply, it is possible to perform write and read.

### SUMMARY

However, there is a problem of deterioration of the nonvolatile semiconductor memory. In particular, these days, miniaturization of a semiconductor process progresses, and a problem of a reduction in reliability is arising along with the price decline of the nonvolatile semiconductor memories. In particular, in a multivalued NAND flash memory that achieves a low cost, a data retention period after rewrites are repeatedly performed is being shortened. In a product that uses the memory, there is an increasing possibility of an occurrence of a data corruption.

For example, Japanese Patent Application Laid-open No. HEI8-241599 and Japanese Patent Translation Publication No. 2010-500699 each disclose a deterioration detection method of a nonvolatile semiconductor memory. In Japanese Patent Application Laid-open No. HEI8-241599, in a nonvolatile semiconductor memory, a write count storage unit that stores a write count is provided, a set value of the write count and an actual write count are compared to each other, and when the set value is exceeded, an alert is issued. Japanese Patent Translation Publication No. 2010-500699 discloses a memory device provided with a stage on which a page including a plurality of sectors is read from a memory array, a stage on which whether the plurality of sectors each include errors within an allowable range in number is determined, and a stage on which, when the plurality of sectors each include the errors within the allowable range, a success indicator is provided.

In the Japanese Patent Application Laid-open No. HEI8-241599 and Japanese Patent Translation Publication No. 2010-500699, a control apparatus (computer) accesses the nonvolatile semiconductor memory, and the write count or the error is read, thereby determining a degree of deterioration by the control apparatus. Therefore, in the state in which the nonvolatile semiconductor memory is not connected to the control apparatus, for example, in the case where the nonvolatile semiconductor memory is held with the memory stored in a cartridge as described above, there is a problem that the deterioration may be incapable of being detected.

In view of the circumstances as described above, it is desirable to provide a memory apparatus and a memory management method capable of detecting deterioration even in the state in which an access is difficult to be performed by a control apparatus or the like.

According to an embodiment of the present disclosure, there is provided a memory apparatus including a detection unit, a storage unit, an update unit, and a determination unit.

The detection unit is configured to detect a deterioration factor of a nonvolatile memory.

The storage unit is configured to hold a lifetime estimation value.

The update unit is configured to update the lifetime estimation value on the basis of the deterioration factor detected by the detection unit.

The determination unit is configured to use the lifetime estimation value updated by the update unit to generate a notification signal.

According to the present disclosure, even in the state of not being connected to the computer, it is possible to detect the deterioration of the nonvolatile memory. For example, in the state of being connected to the computer, the lifetime estimation value is determined from the rewrite count, and the determined lifetime estimation value is held in the storage unit. In the state of not being connected to the computer, the deterioration factor such as the temperature is detected, and the lifetime estimation value is updated depending on the temperature detected. In the case where the updated lifetime estimation value is shorter than a predetermined value, a notification signal to a user is generated.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a diagram for explaining deterioration of a nonvolatile semiconductor memory;

FIG. 2 is a block diagram showing an electrical structure of an embodiment of the present disclosure;

FIG. 3 is a block diagram showing the structure of an example of an interface circuit;

FIG. 4 is a block diagram showing the structure of an example of a nonvolatile semiconductor memory medium;

FIG. 5 is a block diagram showing an example of an internal structure of a flash memory;

FIG. 6 is a diagram showing an example of a lifetime expectancy table;

FIG. 7 is a flowchart for explaining a process performed by a controller at a time of write to the flash memory; and

FIG. 8 is a flowchart for explaining a process of checking a condition of the nonvolatile semiconductor memory medium.

### DETAILED DESCRIPTION

Embodiments of the present disclosure to be described below are desirable specific examples of the present disclosure, and technically desirable various limitations are given. In the following description, however, the present disclosure is not limited to the embodiments unless a description of limiting the present disclosure is given.

The description will be given in the following order.

<1. Deterioration of flash memory>

<2. One embodiment>

<3. Other embodiments>

<4. Modified example>

### 1. Deterioration of Flash Memory

In an embodiment, as an example of a nonvolatile semiconductor memory, a NAND flash memory is used. The present disclosure is also applicable to a NOR flash memory, an EEPROM (electrical erasable programmable ROM), a magnetoresistive RAM (random access memory), a resistance random access memory, a phase-change memory, or the like, as the nonvolatile semiconductor memory other than the NAND flash memory. Further, the present disclosure is also applicable to a nonvolatile memory other than the semiconductor memory, such as a ferroelectric memory.

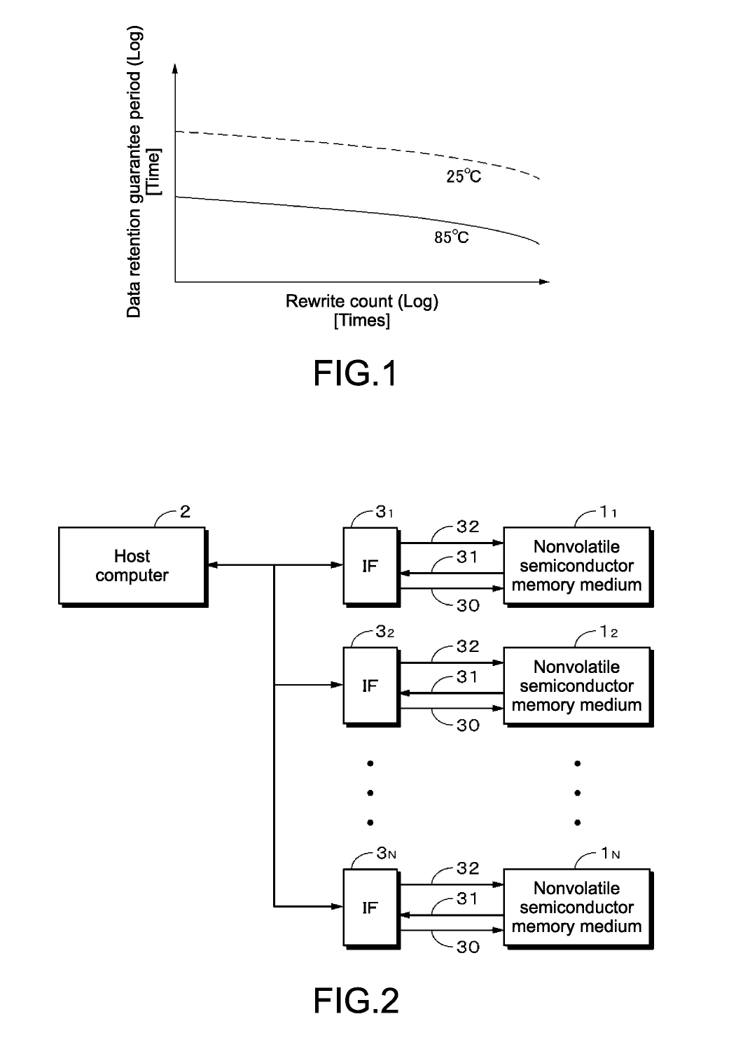

In the NAND flash memory, there occurs such deterioration that a data retention guarantee period becomes shorter as a rewrite count is increased. Further, the higher a temperature is, the shorter the data retention guarantee period becomes. FIG. 1 is a schematic diagram showing a relationship among the rewrite count of the flash memory, the data retention guarantee period thereof, and the temperature. In FIG. 1, the broken line indicates a change of the data retention guarantee period at the temperature of 25° C., and the solid line indicates a change of the data retention guarantee period at the temperature of 85° C. In this way, the data retention guarantee period, which is a period during which stable retention of data in the memory is guaranteed, is reduced as the rewrite count is increased and is changed depending on an ambient temperature. In particular, the higher the temperature is, the shorter the data retention guarantee period becomes.

### 2. One Embodiment

### Structure of Memory Apparatus

FIG. 2 is a diagram showing an electrical structure of the embodiment of the present disclosure. For example, in a cartridge, a nonvolatile semiconductor memory and a peripheral circuit thereof are stored, thereby constituting a nonvolatile semiconductor memory medium. A plurality of nonvolatile semiconductor memory media 11 to 1N (simply referred to as nonvolatile semiconductor memory medium 1 when the media have not to be particularly distinguished from each other) are connected to a host computer 2 through interface circuits 31 to 3N (simply referred to as interface circuit 3 when the circuits have not to be particularly distinguished from each other).

The host computer 2 performs overall control of an entire system. Between the nonvolatile semiconductor memory medium 1 and the host computer 2, an input and an output of data and a supply of power are performed through optical fibers. Three optical fibers are used for each nonvolatile semiconductor memory medium 1. Information from the host computer 2 is transmitted to the interface circuit 3. In the interface circuit 3, in accordance with a command from the host computer 2, a command content and recorded and reproduction data are converted to serial data and transmitted to the nonvolatile semiconductor memory medium 1 through an optical fiber 30 and an optical fiber 31. Further, the interface circuit 3 converts electric power (for example, approximately 2 W) necessary to operate the nonvolatile semiconductor memory medium 1 into optical energy and transmits the optical energy through an optical fiber 32.

In the case where the host computer 2 controls the plurality of nonvolatile semiconductor memory media 1, switching of the control is performed by the interface circuits 3 corresponding to the respective nonvolatile semiconductor memory media 1.

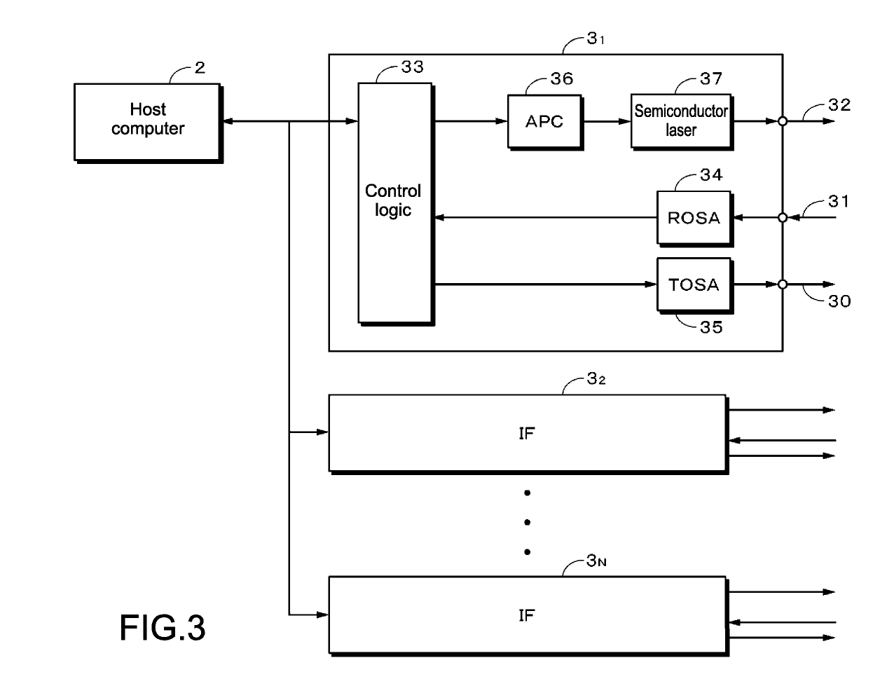

The interface circuit 3, for example, the interface circuit 31 is configured as shown in FIG. 3. The other interface circuits 32 to 3N have the same structure as the interface circuit 31. The information transmitted to and received from the host computer 2 is input to a control logic 33. The control logic 33 analyzes the information from the host computer 2 and determines whether the given command is a command to the nonvolatile semiconductor memory medium 1 in charge thereof or not. In the case of the command in charge thereof, the control logic 33 issues a command to an APC (automatic power control) circuit 36 to boot an output of a semiconductor laser 37.

The APC circuit 36 controls a drive current of the semiconductor laser 37 in such a manner that the semiconductor laser 37 outputs light at a predetermined value (for example, 2 W). The semiconductor laser 37 is, for example, a semiconductor laser with a wavelength of 800 nm and outputs a laser light beam. The laser light beam is transmitted through the optical fiber 32 via a connector. The nonvolatile semiconductor memory medium 1 that receives the laser light beam generates drive electric power from the laser light beam.

Further, the control logic 33 converts the command content from the host computer 2 into serial data and supplies the serial data to a transmitter optical subassembly (TOSA) 35. The transmitter optical subassembly 35 modulates a laser incorporated therein and sends the modulated laser light beam to the optical fiber 30. On the other hand, a receiver optical subassembly (ROSA) 34 converts an optical signal transmitted from the nonvolatile semiconductor memory medium 1 via the optical fiber 31 into an electrical signal and transmits the signal to the control logic 33.

In this way, the control logic 33 establishes optical communication with the nonvolatile semiconductor memory medium 1 through the two optical fibers 30 and 31.

In the embodiment described above, the electric power and signal lines are entirely transmitted through the optical fibers, and an electric connection is not used. As a result, it is possible to connect the nonvolatile semiconductor memory medium 1 with the host computer 2 with the nonvolatile semiconductor memory medium 1 electrically insulated. Because of the connection through the optical fibers, which are insulators, it is possible to prevent the content of the nonvolatile semiconductor memory medium 1 from being damaged, even if a lightning strike occurs in the vicinity thereof, and induced lightning affects an interface line.

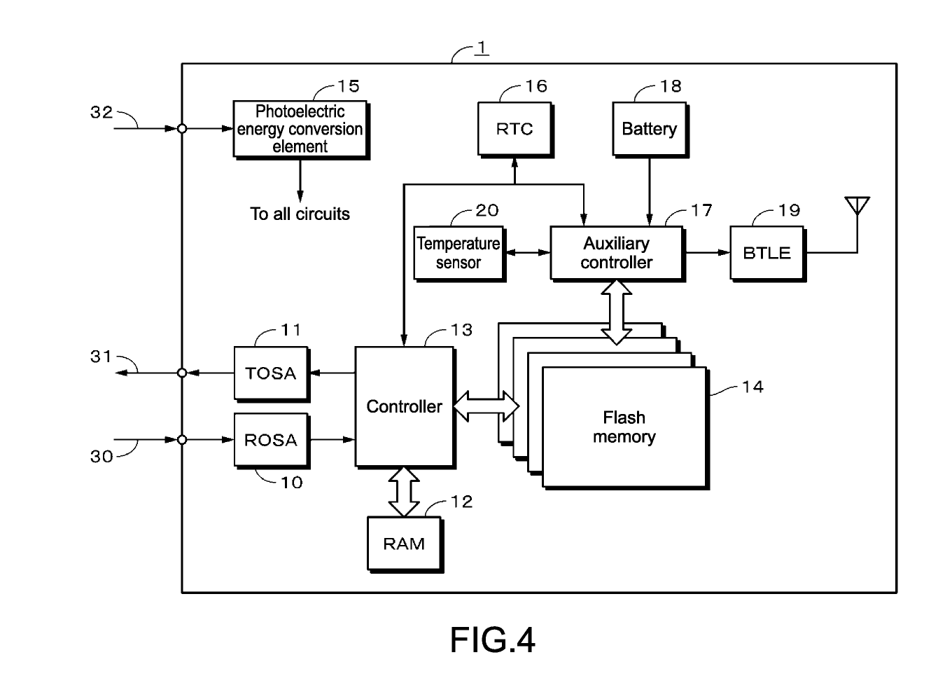

The nonvolatile semiconductor memory medium 1 has the structure as shown in FIG. 4. The optical energy transmitted through the optical fiber 30 is converted to electric energy by a photoelectric energy conversion element 15. The electric energy is supplied to an entire circuit of the nonvolatile semiconductor memory medium 1 as an operation power supply to operate the circuit. As the photoelectric energy conversion element 15, for example, an optical power supply element using a compound semiconductor (gallium arsenide) can be used.

A controller 13 is an IC (integrated circuit) that controls a write operation and a read operation with respect to a flash memory 14. The IC of this type is manufactured by multiple semiconductor makers as a controller dedicated to control of a flash memory. The controller 13 communicates with the interface circuit 3 through the optical fibers 30 and 31, a TOSA 11, and a ROSA 10. When recorded data is transmitted from the interface circuit 3, the controller 13 temporarily stores the recorded data in a RAM 12. After that, the controller 13 writes the recorded data stored in the RAM 12 to a predetermined area in the flash memory 14.

Further, the controller 13 reads the data stored in the flash memory 14 and transmits the data to the host computer 2 through the TOSA 11. In the flash memory, the data is erased on a block or page basis.

Furthermore, the nonvolatile semiconductor memory medium 1 includes a real time clock (represented by RTC in FIG. 4) 16, an auxiliary controller 17, a battery 18, a BTLE 19, and a temperature sensor 20 for measuring the temperature. The real time clock 16 is a chip of a real time clock on which a primary battery is mounted and which operates continuously for a long time period, for example, 10 years or longer. Data at a current time (year, month, day, hour, minute) generated by the real time clock 16 is supplied to the auxiliary controller 17. Further, the real time clock 16 is provided with a nonvolatile memory area which is backed up by the primary battery. The nonvolatile memory area can be accessed by both of the auxiliary controller 17 and the controller 13.

The electric power supplied from the battery 18 is supplied to the auxiliary controller 17. The auxiliary controller 17 is formed of a CPU (central processing unit) having a sleep mode with ultralow power consumption. As the battery 18, a button battery with a large capacity is used, for example. Further, in the case where minute electric power is obtained from a solar battery (not shown) attached to an external surface of a case of the cartridge of the nonvolatile semiconductor memory medium 1, the solar battery may be used instead of the button battery with the large capacity. For example, as a thin-film solid-state secondary battery, a product for which a long lifetime (15 years or more) and charge and discharge counts of 100,000 times or more are guaranteed is available.

The temperature sensor 20 measures a temperature of the nonvolatile semiconductor memory medium 1, for example, a temperature in the cartridge, and supplies a measurement result to the auxiliary controller 17. The BTLE 19 is a low-power wireless communication chip according to Bluetooth (registered trademark) low energy standard. The auxiliary controller 17 wirelessly transmits a notification signal that indicates a deterioration check result such as an alert message to an external server. Another wireless communication module may be used instead of the BTLE. In the case where the check result is transmitted to the server, an ID (identifier) with which the nonvolatile semiconductor memory medium 1 can be be identified is added, and therefore it is possible to identify the nonvolatile semiconductor memory medium 1 to which the check result is related on the server side.

The auxiliary controller 17 uses power supplied from the battery 18 and periodically wakes up to perform automatic activation. The auxiliary controller 17 periodically drives the temperature sensor 20 to measure a temperature of the flash memory 14. A temperature measurement result and information relating to time (year, month, day) when the temperature measurement is performed are stored in the nonvolatile memory area in the real time clock 18.

In the nonvolatile semiconductor memory medium 1 described above, the auxiliary controller 17 is capable of estimating a deterioration condition of the flash memory 14 and transmitting an estimation result to the external server when necessary. This operation is carried out with extremely low power consumption so that the operation is continued even if the energy is not supplied. Therefore, even in the state in which the nonvolatile semiconductor memory medium 1 is not connected to the host computer 2, for example, in a storage state, it is possible to estimate the deterioration condition.

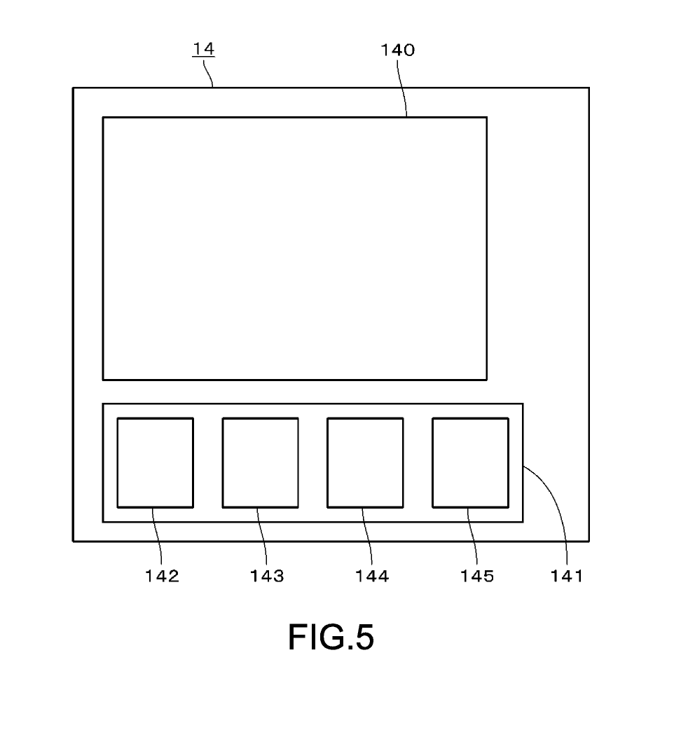

The internal structure of the flash memory 14 is divided into a plurality of memory areas as schematically shown in FIG. 5. A data memory area 140 occupies a largest area and stores the recorded data sent from the host computer 2. A management area 141 stores management information such as addresses of data to be recorded and rewrite counts thereof, and a semiconductor memory chip having a different characteristic (that is, having higher reliability) from the data memory area 140 is used therefor.

An address management area 142 stores a conversion table or the like between an address indicated by the host computer 2 and an address where data is actually held. A rewrite count management table 143 stores information of “how many times the rewrite is performed”. Most of flash memories have such a characteristic that, as the rewrite count is increased, the deterioration progresses, and a storage retention time period is shortened.

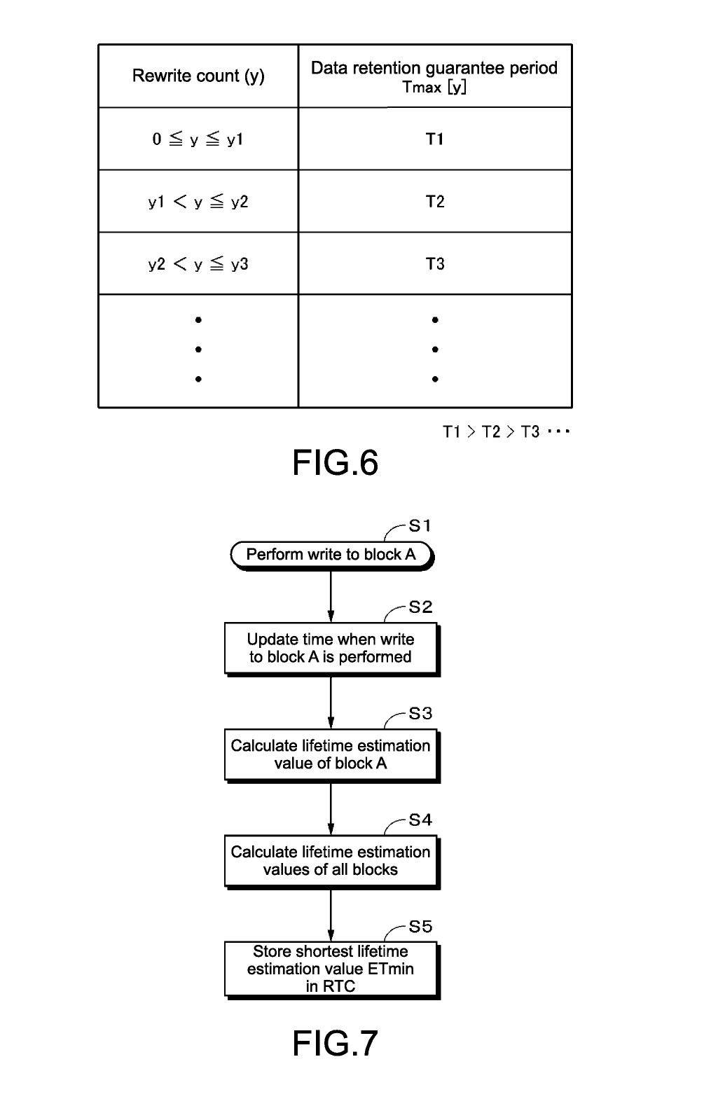

A lifetime expectancy table 144 is a data table in which a time period during which a data retention characteristic is guaranteed (hereinafter, referred to as lifetime expectancy as appropriate) on the basis of the rewrite count. An example of the lifetime expectancy table 144 is shown in FIG. 6. For each range of the rewrite counts (y), a corresponding lifetime expectancy Tmax[y] is determined. The lifetime expectancy is a time period during which retention of data of a block is guaranteed after the block is rewritten.

A write time table 145 is an area in which time when a write is performed for a block is stored. For each block, the write time is stored.

Here, the more a total rewrite count y is, the shorter the lifetime expectancy Tmax[y] becomes (T1>T2>T3 . . . ). It should be noted that the rewrite count y is counted by a function of smoothing the rewrite counts of the blocks, called wearleveling, provided for control software of a typical flash memory. The rewrite counts are stored as management data on the flash memory, so values thereof can be used.

With reference to a flowchart of FIG. 7, a process performed by the controller 13 at a time of performing the write to the flash memory 14 will be described. The write process is performed when the nonvolatile semiconductor memory medium 1 is connected to the host computer 2, and electric power is supplied thereto from the photoelectric energy conversion element 15.

Step S1: Data is newly written to a block A of the flash memory 14.

Step S2: The current time obtained from the real time clock 16 is an area corresponding to the block A in the write time table 145.

Step S3: The controller 13 determines a lifetime estimation value of the block A. That is, a past rewrite count of the block A is determined from the rewrite count management table 143. Then, with reference to the lifetime expectancy table 144, the lifetime expectancy of the block A is determined. Eventually, a write time to the block A is determined from the write time table 145. By adding the lifetime expectancy with respect to the write time, time when data of the block A can be retained is estimated. The time obtained as a result is set as the lifetime estimation value. The lifetime expectancy is the time period, while the lifetime estimation value is the time (year, month, day). However, the lifetime of the nonvolatile semiconductor memory medium 1 may be determined on the basis of not the time but the period of the lifetime expectancy.

Step S4: The controller 13 performs such a check for all the blocks of the flash memory 14.

Step S5: From among the lifetime estimation values obtained from all the blocks, a shortest value is selected and set as a shortest lifetime estimation value ETmin. The controller 13 stores the shortest lifetime estimation value ETmin thus obtained in the nonvolatile memory area in the real time clock.

It should be noted that in the case where there is no new write data, the controller 13 stops the performance to suppress the power consumption.

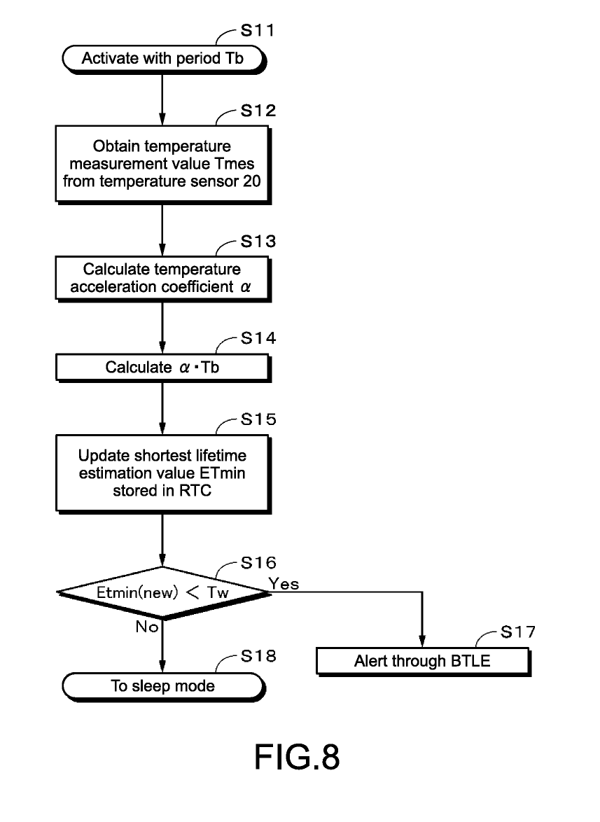

In the state in which the nonvolatile semiconductor memory medium 1 is not connected to the host computer, for example, in the storage state, the auxiliary controller 17 is activated with extremely low power consumption periodically by pulses supplied from the real time clock 16. Further, the auxiliary controller 17 checks the nonvolatile semiconductor memory medium 1. Herein, for convenience of explanation, the assumption is made that the auxiliary controller 17 is activated with a period Tb. With reference to a flowchart of FIG. 8, a process of checking the state of the nonvolatile semiconductor memory medium 1 will be described.

Step S11: The auxiliary controller 17 is activated with the period Tb.

Step S12: The auxiliary controller 17 reads a temperature measurement value Tmes of the temperature sensor 20. The temperature measurement value Tmes indicates a current temperature. The element of the nonvolatile semiconductor memory medium 1 deteriorates exponentially depending on the temperature.

Step S13: The auxiliary controller 17 uses the temperature measurement value Tmes to calculate a temperature acceleration coefficient α with the following equation (1) of the Arrhenius model.

Temperature acceleration coefficient α=exp {(Ea/k)·((1/Tmes)−(1/Tbase))} (1)

The variables in the equation (1) are as follows.

Ea: Activation energy

k: Boltzmann coefficient

Tmes: Absolute temperature measured by the temperature sensor 20

Tbase: Reference absolute temperature (for example, 300 degrees)

Step S14: The auxiliary controller 17 multiplies the temperature acceleration coefficient α and the period Tb, thereby determining a substantial deterioration degree a. Tb.

Step S15: The auxiliary controller 17 reads the shortest lifetime estimation value ETmin stored in the nonvolatile memory area in the real time clock and updates the value as expressed in the following equation.

ETmin[new]=ETmin[old]−α·Tb (2)

In the equation (2), ETmin[new] indicates a current shortest lifetime estimation value. The auxiliary controller 17 returns the value of ETmin[new] into the nonvolatile memory area in the real time clock to update the value.

Step S16: If the shortest lifetime estimation value ETmin[new] becomes 0 or lower, any part of the memory elements recorded in the nonvolatile semiconductor memory medium 1 deteriorates and may reach the end of the life. In view of this, the auxiliary controller 17 compares the updated shortest lifetime estimation value ETmin[new] and a preset alert level Tw with each other. That is, the auxiliary controller 17 checks whether the following expression (3) is satisfied or not. For example, the alert level Tw is time obtained by adding a predetermined margin to the time when the storage retention is guaranteed.

Shortest lifetime estimation value ETmin[new]<Alert level Tw (3)

Step S17: In the case where the expression (3) is satisfied, this means that a part of the memory element of the nonvolatile semiconductor memory medium 1 approaches the end of the life. In this case, the auxiliary controller 17 wirelessly transmits an alert notification based on the deterioration check result to the external server along with the ID of the nonvolatile semiconductor memory medium 1 through the BTLE 19 as the low-power wireless communication chip. Instead of or in addition to the wireless transmission, alert displaying may be performed with a light emitting diode (LED) or the like provided to the case surface of the nonvolatile semiconductor memory medium 1. Further, a sound alert may be generated.

As described above, according to the present disclosure, as the data retention guarantee period of the flash memory which is changed depending on the temperature and the rewrite count, the effective time is calculated by using the temperature sensor, and the alert can be generated in advance. As a result, it is possible to prevent the data from naturally volatilizing during the storage of the nonvolatile semiconductor memory medium 1 and improve reliability. The part operated with the battery operates intermittently with the period Tb, and the energy for the operation is used only for the simple four arithmetic operations and the temperature measurement. Therefore, the power consumption is extremely low, and thus a long-term operation of 10 years or longer can be achieved.

### 3. Another Embodiment

In the embodiment described above, the identification information and the alert notification of the nonvolatile semiconductor memory medium are wirelessly transmitted. Further, when there are a great number of nonvolatile semiconductor memory media managed, it is desirable that information indicating storage positions thereof is used, in addition to specifying of the nonvolatile semiconductor memory media as the identification information.

In another embodiment, along with the check result of the nonvolatile semiconductor memory medium, identification information and storage position information are transmitted. The structure of the nonvolatile semiconductor memory medium in this embodiment is formed by adding a position detection apparatus to the same structure as in the above embodiment. For example, position estimation using Wi-Fi can be used. Further, by a local position information system that uses an ultrasonic ranging technology, a position of the nonvolatile semiconductor memory medium is measured. As another structure, storage positions of shelves can be identified, and the information of the storage positions thereof may be transmitted as the storage position information. Further, position information that indicates the storage areas of a plurality of nonvolatile semiconductor memory media may be used. In this case, light emission of a light-emitting device such as an LED is also used, and the nonvolatile semiconductor memory media are specified eventually.

As in this embodiment, by notifying the server of the storage position of the nonvolatile semiconductor memory medium as an alert target, such an advantage that the medium is easily found out is obtained.

It should be noted that the present disclosure can take the following configurations.

(1) A memory apparatus, including:

a detection unit configured to detect a deterioration factor of a nonvolatile memory;

a storage unit configured to hold a lifetime estimation value;

an update unit configured to update the lifetime estimation value on the basis of the deterioration factor detected by the detection unit; and

a determination unit configured to use the lifetime estimation value updated by the update unit to generate a notification signal.

(2) The memory apparatus according to Item (1), in which

when the nonvolatile memory is accessed by a computer, the lifetime estimation value is determined and stored in the storage unit.

(3) The memory apparatus according to Item (1) or (2), in which

the nonvolatile memory is a semiconductor memory, and the lifetime estimation value is a value obtained on the basis of a rewrite count to the semiconductor memory.

(4) The memory apparatus according to any one of Items (1) to (3), in which

the deterioration factor is a temperature, and the detection unit measures the temperature with a preset period.

(5) The memory apparatus according to any one of Items (1) to (4), in which

the notification signal is transmitted to an external management apparatus by wireless communication.

(6) The memory apparatus according to any one of Items (1) to (5), in which

the notification signal is used to control light emission of a light-emitting element.

(7) The memory apparatus according to any one of Items (1) to (6), in which

the nonvolatile memory, the detection unit, the storage unit, the update unit, and the determination unit are stored in a common case to be transportable.

(8) A memory management method, including:

detecting a deterioration factor of a nonvolatile memory by a detection unit;

holding a lifetime estimation value by a storage unit;

updating, by an update unit, the lifetime estimation value on the basis of the deterioration factor detected by the detection unit; and

using the lifetime estimation value updated to generate a notification signal by a determination unit.

### 4. Modified Example

In the above, the embodiments of the present disclosure are specifically described. However, the present disclosure is not limited to the above embodiments and can be variously modified. For example, the structures, methods, processes, shapes, materials, numerical values, and the like given in the above embodiments are merely examples, and different structures, methods, processes, shapes, materials, numerical values, and the like may be used when necessary. For example, the present disclosure may be applied to the case where a deterioration factor is moisture, an amount of ultraviolet rays, or the like, other than the temperature. Further, the structures, methods, processes, shapes, materials, numerical values, and the like of the above embodiments can be combined with each other without departing from the gist of the present disclosure.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A memory apparatus, comprising:
a detection unit configured to detect a deterioration factor of a nonvolatile memory;
a storage unit configured to hold a lifetime estimation value;
an update unit configured to update the lifetime estimation value on the basis of the deterioration factor detected by the detection unit; and
a determination unit configured to use the lifetime estimation value updated by the update unit to generate a notification signal.

2. The memory apparatus according to claim 1, wherein
when the nonvolatile memory is accessed by a computer, the lifetime estimation value is determined and stored in the storage unit.

3. The memory apparatus according to claim 2, wherein
the nonvolatile memory is a semiconductor memory, and the lifetime estimation value is a value obtained on the basis of a rewrite count to the semiconductor memory.

4. The memory apparatus according to claim 1, wherein
the deterioration factor is a temperature, and the detection unit measures the temperature with a preset period.

5. The memory apparatus according to claim 1, wherein
the notification signal is transmitted to an external management apparatus by wireless communication.

6. The memory apparatus according to claim 1, wherein
the notification signal is used to control light emission of a light-emitting element.

7. The memory apparatus according to claim 1, wherein
the nonvolatile memory, the detection unit, the storage unit, the update unit, and the determination unit are stored in a common case to be transportable.

8. A memory management method, comprising:
detecting a deterioration factor of a nonvolatile memory by a detection unit;
holding a lifetime estimation value by a storage unit;
updating, by an update unit, the lifetime estimation value on the basis of the deterioration factor detected by the detection unit; and
using the lifetime estimation value updated to generate a notification signal by a determination unit.
